(19) United States
(12) Patent Application Publication
(10) Pub. No.: US 2025/0363587 A1
(43) Pub. Date: Nov. 27, 2025

(54) OPTICAL DATA PREPROCESSOR BASED ON OPTICAL NEUROMORPHIC DEVICE

(71) Applicant: UNIVERSITY-INDUSTRY COOPERATION GROUP OF KYUNG HEE UNIVERSITY, Yongin-si (KR)

(72) Inventors: Seong Jun KANG, Seoul (KR); Min Ho PARK, Suwon-si (KR)

(73) Assignee: UNIVERSITY-INDUSTRY COOPERATION GROUP OF KYUNG HEE UNIVERSITY, Yongin-si (KR)

(21) Appl. No.: 19/215,705

(22) Filed: May 22, 2025

(30) Foreign Application Priority Data
May 23, 2024 (KR) 10-2024-0067111

(51) Int. Cl. G06T 1/60; G06N 3/049

(52) U.S. Cl. CPC G06T 1/60; G06N 3/049

(57) ABSTRACT

The present invention provides an optical memory device-based optical data preprocessor and a method thereof, which improves data processing speed and reduces data bottlenecks by storing input optical signals in an overlapped manner and then outputting them as electrical signals for data processing.

### CROSS-REFERENCE TO RELATED APPLICATION

This application claims priority from and the benefit of Korean Patent Application No. 10-2024-0067111 filed on May 23, 2024, in the Korean Intellectual Property Office, the disclosure of which is incorporated herein by reference.

### BACKGROUND OF THE DISCLOSURE

### Field of the Disclosure

The present invention relates to an optical data preprocessor, and more particularly, to an optical memory device-based optical data preprocessor configured to perform data preprocessing by overlapping and outputting optical signals input through an optical memory unit having an optical sensing function and a memory function.

### Description of the Related Art

Artificial intelligence technologies including machine learning and deep learning are being applied in the field of vision processing, which involves analyzing large volumes of image data to derive results across various industrial domains such as autonomous vehicles, the Internet of Things (IoT), semiconductor manufacturing processes, and wearable devices.

However, over the past decade, the energy efficiency of microprocessors has reached a plateau. As a result, current von Neumann-based computing architectures are facing delays in scalability predicted by Moore's Law and are becoming increasingly unsuitable for processing large-scale data due to the high energy consumption required for AI operations.

Accordingly, alternative computing approaches such as neuromorphic computing based on memristor devices and photonics technologies are being developed to address the growing demand for data processing.

From the software perspective, various technologies and studies have been conducted to improve processing or training speeds by performing preprocessing that reduces the number of pixels by lowering the resolution of images used in artificial intelligence training, autonomous driving, and IoT applications.

However, these approaches often result in data loss during the resolution reduction process, which significantly degrades image quality. Consequently, the accuracy of image object analysis or AI inference using the preprocessed data with reduced quality tends to decrease substantially. Another conventional method involves performing preprocessing on images stored in memory.

However, such methods require the conversion of a large number of analog signals received from optical sensors into digital format, followed by storage in non-volatile memory and subsequent processing by a processing unit. This necessitates a complex process and the transmission of all analog data, leading to additional power loss due to large-scale data transfer. Moreover, memory bottlenecks between the memory and the processing unit cause significant delays during preprocessing.

### SUMMARY

The present invention relates to an optical data preprocessor, and more particularly, to an optical memory device-based optical data preprocessor configured to perform data preprocessing by overlapped storage of optical signals using optical memory devices (optical synaptic devices), thereby reducing input optical image data and significantly reducing data transmission between the optical sensor and the processing unit.

Another object of the present invention is to provide an optical memory device-based optical data preprocessor capable of resolving the memory bottleneck between the memory and processor, shortening the data processing time, and significantly reducing power consumption by reducing the amount of input data through overlapping of optical image data in computing systems that require large-scale data processing.

According to an embodiment of the present invention, there is provided an optical data preprocessor comprising:
an optical memory unit including an array of optical memory devices configured to receive a predetermined number of optically input image data that are input in a time-series manner, store the received image data as one overlapped image data, and output the overlapped image data; and
a data preprocessing controller configured to control the number of the predetermined optically input image data overlapped and stored in the overlapped image data and to control the output of the overlapped image data to an external device for image data analysis,
thereby performing data preprocessing that converts the predetermined number of optically input image data into one overlapped image data.

Each of the optical memory devices constituting the optical memory device array may have a photoelectric conversion and memory function that stores the optically input image data in an overlapped manner based on a conductivity change according to the number of times the optical image data are input.

Each of the optical memory devices may include: a substrate; a photoelectric conversion layer stacked on the substrate; and a source electrode and a drain electrode spaced apart from each other and formed on the photoelectric conversion layer.

The photoelectric conversion layer may exhibit suppressed spike-time dependent plasticity (STDP) characteristics and exhibit spike-number dependent plasticity (SNDP) characteristics, so that the conductivity changes are accumulated with the same weight for each of the optically input image data that are input in a time-series manner.

The photoelectric conversion layer may be formed of a metal oxide semiconductor material in which oxygen vacancy ionization is maintained and a predetermined number of input optical image data are overlapped and stored.

The photoelectric conversion layer may be an InGaSnO (IGTO) layer.

The data preprocessing controller may be a spike neural network processor configured to control the number of the predetermined optically input image data to be overlapped and to control the output of the overlapped image data stored in the optical memory unit when the predetermined number of image data are overlapped.

The data preprocessing controller may include: an input/output controller configured to control the output timing of the overlapped image data stored in the array of optical memory devices and to control the number of the predetermined overlapped optical image data and the output of the overlapped image data; a memory configured to store the overlapped image data received from the optical memory unit; and an I/O interface configured to transmit the overlapped image data to an external device for performing image data processing using the overlapped image data under the control of the input/output controller.

The optical data preprocessor may further include an input unit including a lens through which the optical image data are input.

Another embodiment of the present invention provides a method of optical data preprocessing by the optical data preprocessor, the method comprising:
controlling, by the data preprocessing controller, the number of the predetermined optically input image data overlapped and stored in the overlapped image data;
receiving, by the optical memory unit, a predetermined number of optically input image data input in a time-series manner and storing them as one overlapped image data; and
outputting, by the data preprocessing controller, the overlapped image data to an external device for image data analysis.

Another embodiment of the present invention provides an artificial intelligence learning apparatus comprising: the optical data preprocessor; and a post-processor configured to perform artificial intelligence learning using the overlapped image data input from the optical data preprocessor, thereby shortening the artificial intelligence learning time.

According to embodiments of the present invention, it is possible to perform preprocessing that overlaps and reduces historical optical image data by optical memory devices, thereby reducing the amount of data to be processed without causing a memory bottleneck, shortening the processing time for large-scale data such as AI training data, optical sensor data of autonomous vehicles, and optical sensing data for IoT applications.

In addition, by suppressing STDP characteristics and enhancing SNDP characteristics in the optical memory devices, more accurate image preprocessing is enabled, which contributes to shortening AI training time and improving the inference accuracy of the trained model.

The present invention also provides a significant improvement in data compression efficiency by using an image overlapping technique suitable for real-world object recognition environments, enabling accurate identification of moving objects by training AI with overlapped representations of moving object information, rather than relying solely on pixel-level compression within a single frame.

The effects described above are not intended to limit the scope of the present invention, and other effects not explicitly described herein can be clearly understood by those skilled in the art from the following description.

### BRIEF DESCRIPTION OF THE FIGURES

FIG. 1 is a functional block diagram of the optical data preprocessor (1) according to an embodiment of the present invention.

FIG. 2 is a comparative diagram illustrating a conventional visual recognition system and a visual recognition system to which the optical data preprocessor (1) of the present invention is applied.

FIG. 3 is a diagram illustrating an example in which the optical data preprocessor (1) of FIG. 1 is applied to artificial intelligence training for generating an image identification model.

FIG. 4 is a diagram illustrating examples of data preprocessing using the image overlapping method according to an embodiment of the present invention.

FIG. 5 is a diagram illustrating an embodiment of the optical memory device in which STDP is suppressed and SNDP is maintained.

FIG. 6 is a graph showing optical response results of the IGTO-based optical memory device (a) and the IGZO-based optical memory device (b).

FIG. 7 is a graph comparing the conductivity retention characteristics in the absence of light after optical pulse application between the IGTO-based optical memory device (a) and the IGZO-based optical memory device (b).

FIG. 8 is a graph comparing the conductivity changes according to the number and timing of optical pulses applied to the IGTO-based optical memory device (a) and the IGZO-based optical memory device (b).

FIG. 9 is a diagram illustrating the conductivity storage states according to optical pulse timing for the IGTO-based optical memory device (a) and the IGZO-based optical memory device (b).

### DETAILED DESCRIPTION OF THE DISCLOSURE

The structural or functional descriptions provided herein are merely illustrative of exemplary embodiments according to the concept of the present invention and are not intended to limit the invention. The embodiments according to the concept of the present invention may be implemented in various forms and are not limited to those described in this specification.

Embodiments according to the concept of the present invention may undergo various modifications and take on various forms. Thus, the embodiments are illustrated in the drawings and described in detail in the specification. However, this is not intended to limit the embodiments to any particular form of disclosure, and it is to be understood that the present invention includes modifications, equivalents, and substitutions falling within the spirit and scope of the invention.

Terms such as “first,” “second,” and the like may be used to describe various components but should not be construed as limiting the components by such terms. These terms are only used to distinguish one component from another. For example, a first component may be termed a second component without departing from the scope of the invention, and likewise, the second component may be referred to as the first component.

When a component is described as being “connected to” or “coupled to” another component, it should be understood that it may be directly connected or coupled to the other component or may be indirectly connected or coupled through one or more intermediate components. On the other hand, when a component is described as being “directly connected to” or “directly coupled to” another component, it should be understood that there are no intervening components. Expressions describing relationships between components, such as “between” and “immediately between” or “directly adjacent to,” should be interpreted in a similar manner.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. Furthermore, the terms “comprise,” “include,” or “have,” and variations thereof, are intended to designate the presence of stated features, numbers, steps, operations, components, or combinations thereof, but do not preclude the presence or addition of one or more other features, numbers, steps, operations, components, or combinations thereof.

Unless otherwise defined, all terms used herein (including technical and scientific terms) have the same meanings as commonly understood by one of ordinary skill in the art to which this invention belongs. Terms generally used in dictionaries should be interpreted as having meanings consistent with their contextual use in the relevant technical field, and are not to be interpreted in an idealized or overly formal sense unless expressly defined herein.

Hereinafter, exemplary embodiments will be described in detail with reference to the accompanying drawings. However, the scope of the present disclosure is not limited to these embodiments. The same reference numerals in the respective drawings denote the same elements.

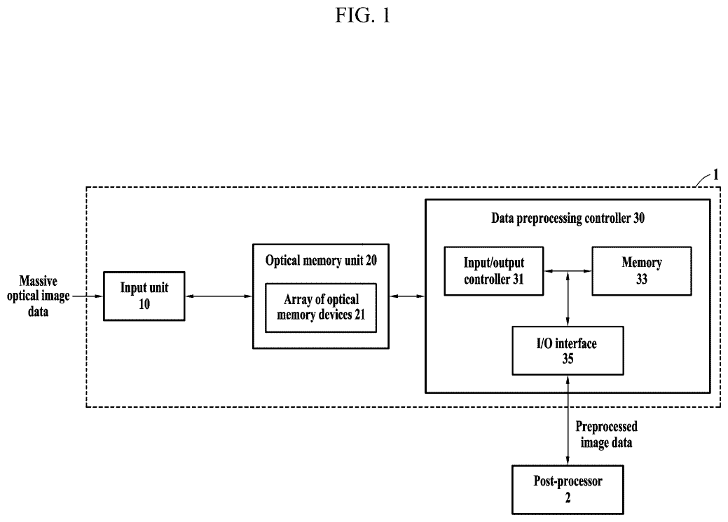

FIG. 1 is a functional block diagram of the optical data preprocessor (1) according to an embodiment of the present invention.

As shown in FIG. 1, the optical data preprocessor (1) may include an input unit (10), an optical memory unit (20), and a data preprocessing controller (30).

The input unit (10) may include a lens through which the optical image data are input. The lens may be implemented as a single lens.

The optical memory unit (20) may include an array of optical memory devices configured to receive a predetermined number of optically input image data input in a time-series manner, store them as one overlapped image data, and output the overlapped image data to perform data preprocessing that reduces the amount of input data.

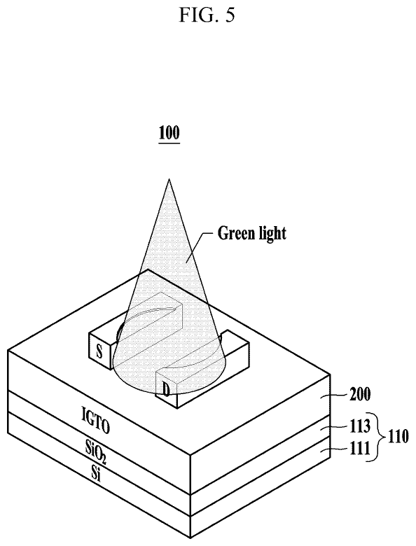

Each of the optical memory devices (100; see FIG. 5) constituting the array of optical memory devices (21) may be a device having a photoelectric conversion and memory function for overlapped storage of the optical image data based on a conductivity change according to the number of times the optical image data are input. The memory function may be a synaptic memory function that mimics visual cells, configured to overlappedly store the input optical image data and output them in the form of spikes.

The array of optical memory devices (21) may be applied to in-sensor computing, in which the optical image data input are overlapped and transmitted in the form of spikes, thereby mimicking human visual perception.

The optical memory devices (100; see FIG. 5) may include an optical memory material in which a predetermined number of input optical image data are overlapped and stored.

The optical memory material may exhibit suppressed spike-time dependent plasticity (STDP) characteristics and exhibit spike-number dependent plasticity (SNDP) characteristics.

The STDP characteristic refers to a property in which information is stored with different weights depending on the timing of receiving optical signals, even when the number of received signals is the same, and the stored information degrades over time. Accordingly, when the optical memory device (100) exhibits STDP characteristics, the weight of information stored earlier significantly decreases, while the weight of information stored later significantly increases. Therefore, if the STDP characteristic is dominant, problems may arise in optical image data preprocessing when noise is introduced at the end of the input sequence.

The SNDP characteristic refers to a property in which resistance changes based on the number of received optical pulses. An optical memory device (100) exhibiting SNDP characteristics can store information corresponding to the number of input optical pulses. The SNDP characteristic enables information to be stored with equal weight per received optical signal, regardless of the timing. In other words, each piece of optical image data can be stored uniformly and accurately, with the same weight, irrespective of the order or time of input.

Because the SNDP characteristic enables the final optical signal (even if it is noise) to be stored with the same weight as earlier signals, information previously stored can be preserved. When the optical memory device (100) exhibits suppressed STDP and maintains SNDP characteristics, N optical image data input in a time-series manner are stored as a single overlapped image data compressed by averaging the values of the N optical image data.

The compressed overlapped image data may contain information corresponding to all N optical image data. Accordingly, the optical memory device (100) may serve as an optical neuromorphic device that mimics visual cells.

Furthermore, when artificial intelligence training is performed using the compressed overlapped image data, the effect of training with all N optical image data simultaneously can be achieved.

The optical memory device (100) may be configured to overlappedly store the predetermined number of optical image data based on a cumulative change in conductivity caused by photoelectric conversion performed with the same weight for each of the optically input pulses in a time-series manner, by exhibiting suppressed spike-time dependent plasticity (STDP) characteristics and maintaining spike-number dependent plasticity (SNDP) characteristics.

The data preprocessing controller (30) may be configured to control the output of the overlapped image data stored in the optical memory unit (20) to an external device (post-processor (2)) for image data analysis.

The data preprocessing controller (30) may be configured to control the number of the predetermined optical image data that are overlapped in the overlapped image data. The data preprocessing controller (30) may be a spike neural network processor configured to control the output of the overlapped image data stored in the optical memory unit (20) when the predetermined number of optical image data have been overlapped.

The data preprocessing controller (30) may comprise an input/output controller (31), a memory (33), and an I/O interface (35).

The input/output controller (31) may be configured to control the output timing of the overlapped image data stored in the array of optical memory devices (21), and to control the number of the predetermined optical image data to be overlapped as well as the output of the overlapped image data.

The memory (33) may be a memory configured to store the overlapped image data, which is an electrical signal received from the optical memory unit (20). The memory may include at least one of volatile memory or non-volatile memory.

The I/O interface (35) may be configured to transmit the overlapped image data to an external device (post-processor (2)) for performing image data processing using the overlapped image data, under the control of the input/output controller (31). The I/O interface (35) may be configured to input and output data in at least one of a serial or parallel mode, and preferably, the I/O interface (35) may be configured to input and output data in a parallel mode.

The post-processor (2) may include a programmed algorithm configured to perform object extraction, recognition, and prediction from the overlapped image data. The post-processor (2) may also include an artificial intelligence model trained by an AI algorithm to perform object extraction, recognition, and prediction from the overlapped image data.

The optical data preprocessor (1) having the above-described configuration may be configured to receive a predetermined number of optical image data input in a time-series manner, and to overlappedly store the predetermined number of optical image data by accumulating identical changes in conductivity caused by the optical signal of each optical image data input. Thereafter, once the predetermined number of optical image data have been overlapped and stored, the cumulative conductivity magnitude is output to an external post-processor (2) as an overlapped image data signal representing the overlapped optical image data.

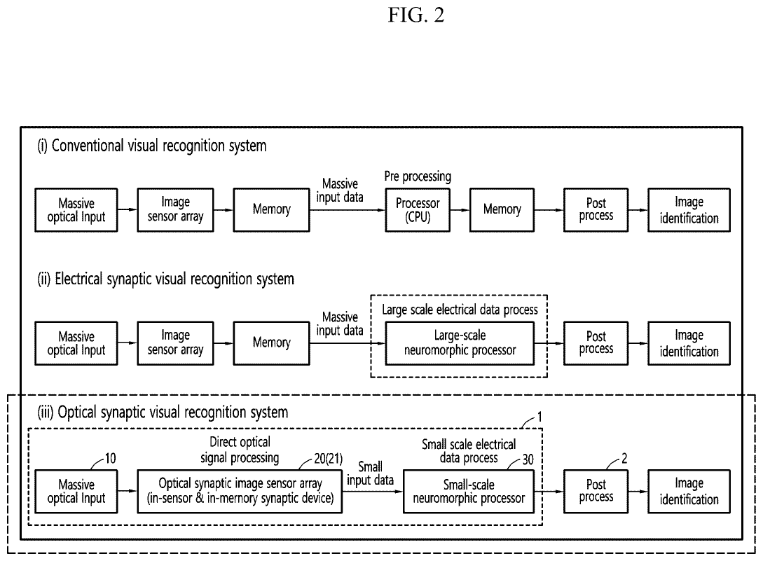

FIG. 2 is a comparative diagram illustrating a conventional visual recognition system and a visual recognition system according to an embodiment in which the optical data preprocessor (1) of the present invention is applied.

Sub-diagram (i) of FIG. 2 is a functional block diagram of a conventional visual recognition system. Sub-diagram (ii) is a functional block diagram of a conventional electrical synaptic visual recognition system. Sub-diagram (iii) is a functional block diagram of an optical synaptic visual recognition system to which the optical data preprocessor (1) of the present invention is applied.

In the conventional visual recognition system (FIG. 2(i)), a massive optical input is converted into a large volume of electrical signals through an image sensor array and stored in memory. The image data converted into electrical signals and stored in memory are then transmitted to a processor (CPU) that performs data preprocessing. In this case, due to the large volume of image data, a data bottleneck may occur, and a high-performance processor is required to handle the preprocessing of the large-scale image data.

In the conventional electrical synaptic visual recognition system (FIG. 2(ii)), a massive optical input is similarly converted into a large volume of electrical signals through an image sensor array and stored in memory. The stored electrical signals are then transmitted to a neuromorphic processor for processing. Even in this configuration, a data bottleneck may occur due to the large volume of image data, and a large-scale neuromorphic processor is needed to handle the processing.

In contrast, the optical synaptic visual recognition system (FIG. 2 (iii)) according to an embodiment of the present invention stores a single overlapped image data by overlapping a predetermined number (e.g., N) of optical images included in the massive optical input through the array of optical memory devices (21). As a result, the input data can be reduced by a factor of 1/N. Accordingly, the data bottleneck between the array of optical memory devices (21), which functions as memory, and the neuromorphic processor (i.e., the data preprocessing controller (30)) can be minimized. Furthermore, by reducing the input data, computational processing time and power consumption are reduced, enabling the use of a low-specification neuromorphic processor.

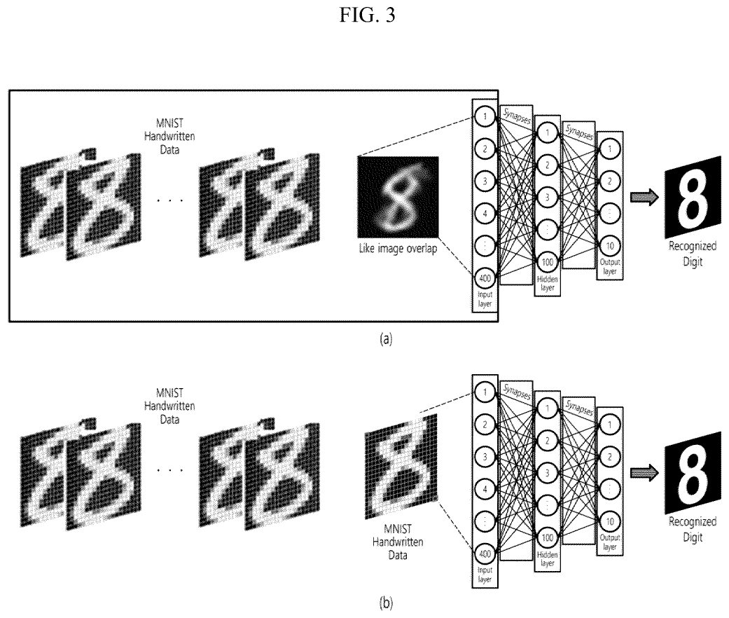

FIG. 3 is diagrams illustrating an example in which the optical data preprocessor (1) of FIG. 1 is applied to artificial intelligence training for generating an image identification model.

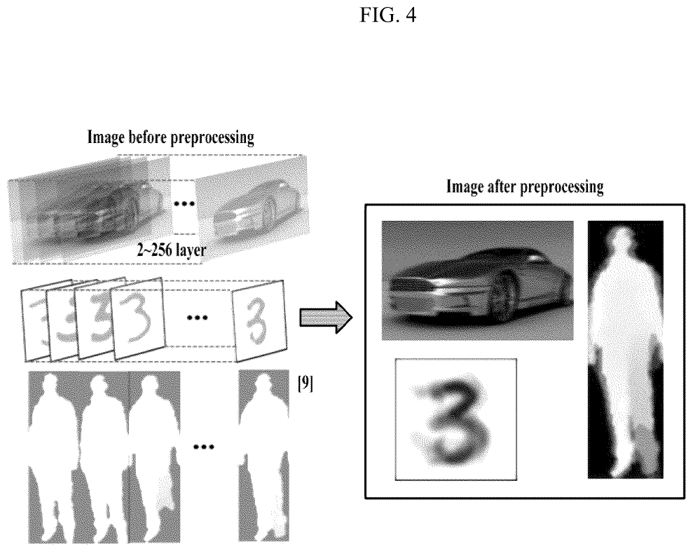

FIG. 4 is a diagram illustrating examples of data preprocessing using the image overlapping method according to an embodiment of the present invention.

(a) of FIG. 3 illustrates a training process of an image identification model trained to identify images from optical image data processed by the optical data preprocessor (1) of the present invention. (b) of FIG. 3 illustrates a process of generating an image identification model in which each individual optical image data is converted into electrical image data and applied as input to an artificial intelligence learning algorithm, as in the conventional approach.

As shown in (a) of FIG. 3 and FIG. 4, the optical data preprocessor (1) according to the embodiment stores a predetermined number of optical image data as a single overlapped image data and applies it as input to an artificial intelligence learning algorithm. Accordingly, the amount of input data fed into the artificial intelligence learning algorithm can be reduced to [1/(the predetermined number of optical image data)]. As a result, the optical data preprocessor (1) significantly accelerates the speed of artificial intelligence learning.

This improvement in processing speed can not only accelerate AI learning but also significantly enhance the speed of data processing for optical signal-based object detection, recognition, or inference in vision processing applications such as the Internet of Things (IoT) and autonomous driving.

In contrast, as shown in (b) of FIG. 3, the artificial intelligence training process for generating an image identification model in the conventional approach does not perform overlapped storage of optical image data. Consequently, each individual optical image data is converted into an electrical signal and applied directly as input, resulting in a large input data volume. Therefore, the speed of artificial intelligence learning is significantly reduced.

FIG. 5 is a diagram illustrating an embodiment of the optical memory device (100) in which spike-time dependent plasticity (STDP) is suppressed and spike-number dependent plasticity (SNDP) is maintained.

As shown in FIG. 5, the optical memory device (100) may include a substrate (110), a photoelectric conversion layer (200) stacked on the substrate (110), and source and drain electrodes (S and D) spaced apart from each other and formed on the photoelectric conversion layer (200).

The photoelectric conversion layer (200) may be formed of a metal oxide semiconductor material in which a predetermined number of input optical image data are overlapped and stored. The metal oxide semiconductor material may be a material in which an oxygen vacancy ionization state is maintained. The metal oxide semiconductor material may be InGaSnO (IGTO). By maintaining the oxygen vacancy ionization state, the photoelectric conversion layer (200) may exhibit suppressed spike-time dependent plasticity (STDP) characteristics and exhibit spike-number dependent plasticity (SNDP) characteristics.

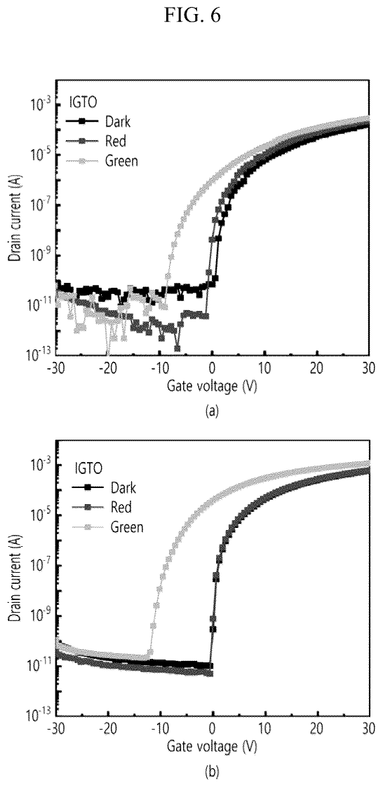

FIG. 6 is graphs showing the optical response results of the IGTO-based optical memory device (a) and the IGZO-based optical memory device (b).

As shown in FIG. 6, both the IGTO-based optical memory device (100) (a) according to the embodiment and the IGZO-based optical memory device (b) of the prior art exhibited an optical response in which the conductivity varied in response to incident green light.

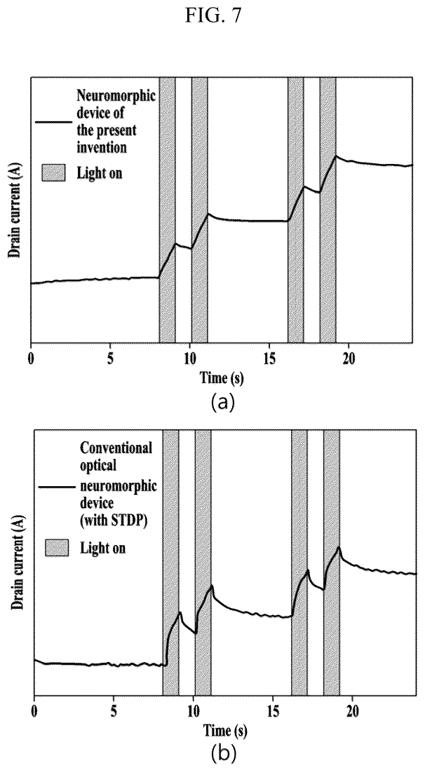

FIG. 7 is graphs comparing the conductivity retention characteristics in the absence of light after optical pulse application between the IGTO-based optical memory device (a) and the IGZO-based optical memory device (FIG. 7(b)).

(a) of FIG. 7 shows a conductivity retention graph of the IGTO-based optical memory device of FIG. 5, measured under conditions where no light is incident after the application of optical pulses.

(b) of FIG. 7 shows a conductivity retention graph of the IGZO-based optical memory device, also measured under conditions where no light is incident after the application of optical pulses.

As shown in (a) of FIG. 7, it was confirmed that the IGTO-based optical memory device (100) according to the embodiment of the present invention exhibits SNDP (spike-number dependent plasticity) characteristics, in which the conductivity increases as multiple optical pulses are applied. Furthermore, even after the optical pulses are applied and no light is incident, the conductivity remains stable, confirming that the STDP (spike-time dependent plasticity) characteristics are suppressed.

As shown in (b) of FIG. 7, the IGZO-based optical memory device also exhibits SNDP characteristics in which conductivity increases with the application of multiple optical pulses. However, it was confirmed that the conductivity decreases under conditions without incident light after pulse application, indicating that STDP characteristics are present.

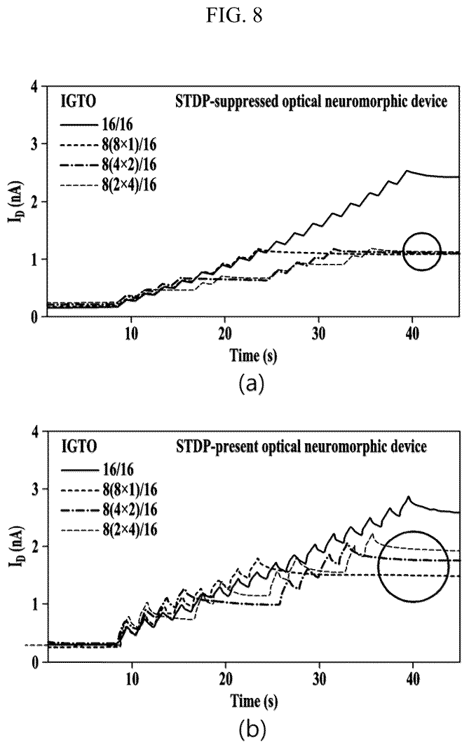

FIG. 8 is graphs comparing the conductivity changes according to the number and timing of optical pulses applied to the IGTO-based optical memory device (a) and the IGZO-based optical memory device (b).

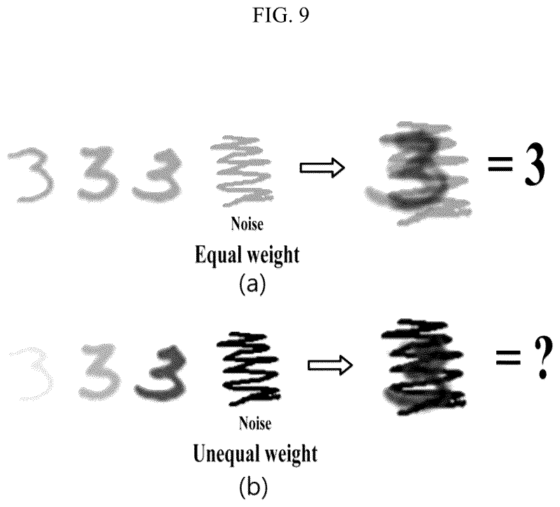

FIG. 9 is diagrams illustrating the conductivity storage states according to the optical pulse timing for the IGTO-based optical memory device (a) and the IGZO-based optical memory device (b).

As shown in (a) of FIG. 8 and (a) of FIG. 9, in the case of the IGTO-based optical memory device (100) according to the embodiment, the drain current increased uniformly in response to the number of applied optical pulses, while it was confirmed that the increase in drain current was independent of the pulse application timing. In other words, the IGTO-based optical memory device stored a uniform conductivity regardless of the pulse timing, indicating that the weight—i.e., the rate of conductivity change caused by each optical image data—was uniform.

In contrast, as shown in (b) of FIG. 8 and (b) of FIG. 9, the IGZO-based optical memory device exhibited an increase in drain current with the number of optical pulses applied; however, the increase varied depending on the timing of the pulse application. That is, the IGZO-based optical memory device stored different levels of conductivity depending on when the optical pulses were applied, resulting in non-uniform weights corresponding to each optical image data.

Accordingly, the optical memory device (100) according to the embodiment of the present invention, which suppresses STDP characteristics and exhibits SNDP characteristics, enables accurate storage of overlapped image data by preserving the contribution of each optical image data. Even when noise is introduced in the final optical image data during the overlapped storage of a predetermined number of optical image data, the resulting overlapped image data accurately reflects the information of all optical image data.

In contrast, the IGZO-based optical memory device (100), which exhibits both STDP and SNDP characteristics, showed that when noise occurred in the final optical image data during overlapped storage, the weight of the final data became dominant, resulting in the loss of information from the preceding optical image data in the overlapped image data.

In another embodiment of the present invention, an optical data preprocessing method using the above-described optical data preprocessor may be provided. The method may include:
controlling, by the data preprocessing controller, the number of the predetermined optical image data overlapped and stored in the overlapped image data;
receiving, by the optical memory unit, a predetermined number of time-series optical image data and storing them as one overlapped image data; and
outputting, by the data preprocessing controller, the overlapped image data to an external device for performing image data analysis.

As described above, the optical data preprocessor (1) and method according to the embodiment of the present invention can significantly reduce the volume of optical image data by performing data preprocessing that overlappedly stores and outputs large-scale input optical image data. As a result, it can dramatically improve the data processing speed for computer vision-related artificial intelligence learning, the Internet of Things (IoT), and autonomous driving, while also significantly reducing power consumption.

In addition, since image preprocessing is performed inside the sensor (optical memory device (100)) in the optical data preprocessor (1) and method of the present invention, fast object recognition is possible, thereby enabling real-time artificial intelligence inference.

The optical data preprocessor (1) and method of the present invention are applicable not only to input data processing for training artificial intelligence models but also to a wide range of computer vision models, ensuring a high level of compatibility.

Accordingly, the optical data preprocessor (1) of the present invention can be applied to an artificial intelligence learning apparatus. As shown in FIG. 1, the artificial intelligence learning apparatus may include the optical data preprocessor (1) and an external post-processor (2) configured to perform artificial intelligence learning using the overlapped image data input from the optical data preprocessor. Because the optical image data are overlapped and compressed by the optical data preprocessor (1), the input data volume is reduced to 1/N, where N is the number of overlapped optical image data, thereby significantly improving the speed of artificial intelligence learning.

In the case of autonomous vehicles, object recognition is typically performed by storing images frame by frame and preprocessing them before classification. Therefore, by applying the optical data preprocessor (1) and method of the present invention to an in-sensor computing system, it becomes possible to perform image preprocessing without passing through a processing unit or memory, thereby enabling faster object recognition.

That is, the optical data preprocessor (1) and method of the present invention can be applied to various technical and industrial fields, including smartphone camera optical sensors, smart factory optical sensors, autonomous vehicle optical sensors, computer vision machine learning systems, and optical sensors in wearable devices. Through such applications, improvements in data processing speed and reductions in power consumption can be achieved.

Accordingly, the optical data preprocessor and method of the present invention may generate significant demand in business sectors where real-time object recognition AI is utilized, such as autonomous driving, the Internet of Things (IoT), and wearable devices.

While the embodiments have been described above with reference to limited drawings, it will be understood by those skilled in the art that various modifications and alterations can be made based on the above disclosure. For example, the described technologies may be executed in an order different from the illustrated method; and/or the components of the described systems, structures, devices, or circuits may be combined, configured, or substituted in forms different from those illustrated or described, or replaced with other components or equivalents to achieve substantially the same results.

Therefore, other implementations, alternative embodiments, and equivalents that fall within the scope of the appended claims shall also be regarded as being within the technical scope of the present invention.

What is claimed is:

1. An optical data preprocessor comprising:
an optical memory unit including an array of optical memory devices configured to receive a predetermined number of optically input image data that are input in a time-series manner, store the received image data as one overlapped image data, and output the overlapped image data; and
a data preprocessing controller configured to control the number of the predetermined optically input image data overlapped and stored in the overlapped image data and to control the output of the overlapped image data to an external device for image data analysis.

2. The optical data preprocessor of claim 1,
wherein each of the optical memory devices constituting the array of optical memory devices is configured to have a photoelectric conversion and memory function that stores the optically input image data in an overlapped manner based on a conductivity change according to the number of times the optical image data are input.

3. The optical data preprocessor of claim 2,
wherein each of the optical memory devices comprises:
a substrate;
a photoelectric conversion layer stacked on the substrate; and
a source electrode and a drain electrode spaced apart from each other and formed on the photoelectric conversion layer.

4. The optical data preprocessor of claim 3,
wherein the photoelectric conversion layer exhibits suppressed spike-time dependent plasticity (STDP) characteristics and exhibits spike-number dependent plasticity (SNDP) characteristics, so that the conductivity changes are accumulated with the same weight for each of the optically input image data that are input in a time-series manner.

5. The optical data preprocessor of claim 3,
wherein the photoelectric conversion layer comprises a metal oxide semiconductor material in which the predetermined number of input optical image data are overlapped and stored.

6. The optical data preprocessor of claim 3,
wherein the photoelectric conversion layer comprises an InGaSnO (IGTO) layer.

7. The optical data preprocessor of claim 1,
wherein the data preprocessing controller is a spike neural network processor configured to control the number of the predetermined optically input image data to be overlapped in the overlapped image data, and to control the output of the overlapped image data stored in the optical memory unit when the predetermined number of image data are overlapped.

8. The optical data preprocessor of claim 1,
wherein the data preprocessing controller comprises:
an input/output controller configured to control the output timing of the overlapped image data stored in the array of optical memory devices and to control the number of the predetermined overlapped optical image data and the output of the overlapped image data;
a memory configured to store the overlapped image data received from the optical memory unit; and
an I/O interface configured to transmit the overlapped image data to an external device for performing image data processing using the overlapped image data under the control of the input/output controller.

9. The optical data preprocessor of claim 1,
further comprising an input unit including a lens through which the optical image data are input.

10. A method of optical data preprocessing by the optical data preprocessor of claim 1, the method comprising:
controlling, by the data preprocessing controller, the number of the predetermined optically input image data overlapped and stored in the overlapped image data;
receiving, by the optical memory unit, a predetermined number of optically input image data input in a time-series manner and storing them as one overlapped image data; and
outputting, by the data preprocessing controller, the overlapped image data to an external device for image data analysis.

11. An artificial intelligence learning apparatus comprising:
the optical data preprocessor of claim 1; and
a post-processor configured to perform artificial intelligence learning using the overlapped image data input from the optical data preprocessor,
wherein the artificial intelligence learning time is reduced.
